(19) United States
(12) Patent Application Publication
(10) Pub. No.: US 2002/0019867 A1
(43) Pub. Date: Feb. 14, 2002

(54) Data transmission to network management system

(76) Inventor: Jarmo Pulkkinen, Pirkkala (FI)

Correspondence Address: Pillsbury Winthrop LLP, Intellectual Property Group, 1600 Tysons Boulevard, McLean, VA, 22102, US

(21) Appl. No.: 09/930,185

(22) Filed: Aug. 16, 2001

Related U.S. Application Data
(63) Continuation of application No. PCT/FI00/00152, filed on Feb. 24, 2000.

(30) Foreign Application Priority Data
Feb. 24, 1999 (FI) 990401

(51) Int. Cl. G06F 15/173

(52) U.S. Cl. 709/223; 709/217

(57) ABSTRACT

The invention relates to data transmission from a network element to a network management system. In the invention, a response to be transmitted to the network management system is provided (306, 308) with at least one pointer indicating the location where to find additional information, before the response is transmitted. When requested by the operator, the network management system opens the additional information from the location indicated by the pointer. Thus, the operator need not establish a separate session and search information.

This application is a Continuation of International Application PCT/FI00/00152 filed Feb. 24, 2000 which designated the U.S. and was published under PCT Article 21(2) in English.

### BACKGROUND OF THE INVENTION

The invention relates to data transmission from a network element to a network management system.

A network includes one or more centralized network management systems NMS for managing and monitoring it. By means of a network management system network faults are monitored in real time and alarms are handled, for example. A network management system is in fact a group of integrated applications by which apparatuses in the network can be managed and controlled. Network management includes fault management, accounting management, configuration management, performance management and security management.

A typical telecommunications network comprises a wide variety of network elements. A mobile communications network, for instance, comprises switching centres, base stations, transmission nodes etc. A local area network for its part comprises file servers, printer servers, hubs, routers etc. A large network may comprise tens of thousands of network elements. Each network element in turn may comprise several independent units. Due to this complexity in the network concept, a large amount of faults occur daily in the network. Depending on its settings, the network element may transmit one or more failure reports, or alarms, concerning the fault, or the fault alarm is not transmitted at all.

When an alarm arrives at the network management system and a maintenance person wants to examine it in more detail, he has to establish a remote session (MML session) with the network element that sent the alarm and try to find background information on the fault there. The alarm itself can also include some information, but typically the background information transferred in alarms is minimal. In a remote session the network management system has to communicate with various network elements in the manner that is understood by network elements, i.e. in their own man-machine languages, which are e.g. in switching centres manufacturer- and type-specific. New versions of man-machine languages are also produced along with the system levels of different switching centres of the same manufacturer and along with new versions of a program. Several interfaces are needed between a control system and network elements.

A problem of the above arrangement is that the optimization between the efficient use of network resources and the sufficient background information is very difficult. If the alarm is provided with very little information, the operator may need to establish a separate remote session (MML session), which is slow and inflexible, and the information provided in the alarm cannot necessarily be found very easily. In addition, the information in the alarm is often difficult to comprehend, because the amount of bits to be transferred is minimized. If, on the other hand, alarms transmit enough information to state the seriousness of the fault and enough background information to correct the fault, the network resources are wasted, if the operator does not use the information after all. Another problem is that different interfaces have to be used with different network elements. The amount of interfaces is likely to increase particularly when the so-called third generation mobile communications systems, such as the Universal Mobile Telecommunications System (UMTS) and IMT-2000 (International Mobile Telecommunications 2000), come to market. The management of various interfaces makes the network management system very complicated.

### BRIEF DESCRIPTION OF THE INVENTION

The object of the invention is to simplify the network management system and simultaneously to reduce the information transferred in the network as signalling in such a manner that the necessary information relating to e.g. alarm can be easily found. The objects of the invention are achieved by a method of data transmission to a network management system, which method is characterized by providing a response to be transmitted to the network management system with at least one pointer indicating the location where to find additional information, and transmitting the response to the network management system.

A pointer refers herein to an identification or indicator of the location area of information. A pointer can be e.g. an address, algorithm or code for generating the address, key word, destination or source designator.

The invention also relates to a network element of a telecommunications network, which network element is adapted to be in connection with the network management system of the telecommunications network by transmitting responses to it. The network element is characterized in that it is adapted to provide a response to be transmitted with a pointer indicating the location where to find additional information.

The invention further relates to a network management system of a telecommunications network, which network management system is adapted to receive responses from network elements of the telecommunications network. The network management system is characterized in that it is adapted to identify a pointer in a response, the pointer indicating where to find additional information.

The invention is based on the idea that the network element provides the alarm or other information it transmits to the network management system with a pointer, by which the network element shows where to find additional information. This additional information can be e.g. measurement data, a diagnostics report, covered alarms of lower priority or a page in an alarm reference manual. Additional information can also be a load report, a current configuration or any information regarding network monitoring or analysing.

The invention provides a flexible way, which requires little data transmission capacity, to convey additional information to the operator. An advantage of the invention is that the network management system has direct links to the additional information in the network elements, whereby the amount of information to be transmitted can be minimized and the definition of various interfaces can be simplified.

In a preferred embodiment of the invention additional information is stored in a predetermined form in a predetermined location. This provides the advantage that each network element can be provided with the most suitable storing method.

The preferred embodiments of the method, network element and network management system according to the invention are disclosed in the dependent claims.

### BRIEF DESCRIPTION OF THE DRAWINGS

In the following the invention will be described in greater detail in connection with the preferred embodiments with reference to the attached drawings, in which:

FIG. 1 shows a simple block diagram of a telecommunications network of the invention;

FIGS. 2 and 3 show a flow chart of the operation of a network element of the invention; and

FIG. 4 shows a flow chart of the operation of a network management system.

### DETAILED DESCRIPTION OF THE INVENTION

The present invention can be used in the network management of any telecommunications network when the network elements transmit information on their state, e.g. alarms or capacity measurements, to the network management system.

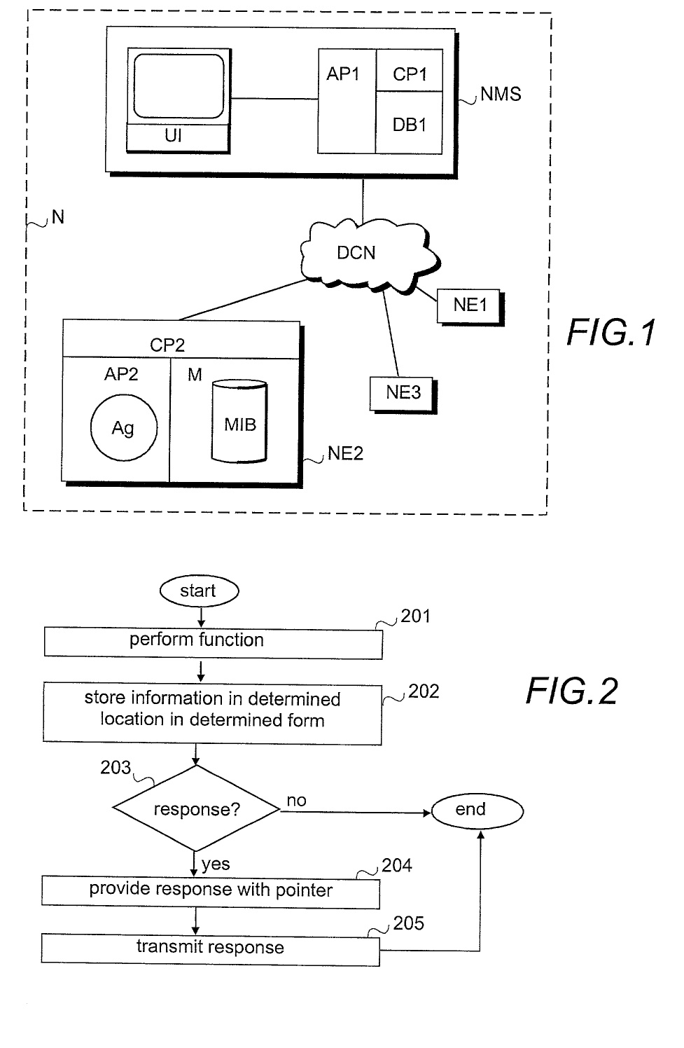

FIG. 1 shows a simplified block diagram of a network N of the invention and its network management system NMS. The network of the invention can be any network, such as the UMTS network, Pan-European digital mobile communications network GSM or network based on the GSM, integrated services digital network ISDN, local area network LAN, public land mobile network PLMN etc.

In FIG. 1, the network management system NMS is connected to the network elements NE1, NE2, NE3 of the network N via the data communication network DCN. In this case, a data communication network refers generally to any connection and network by which a network management system and network elements can be connected with each other. A data communication network DCN can be e.g. a packet-switched network, an Ethernet network or a TCP/IP network. It is not significant for the invention, what kind of interfaces or protocols the NMS uses when communicating with network elements. The used connection and protocol can vary depending on the network element, as long as responses can be transmitted from the network element to the network management system and the network management system can establish a connection with the location indicated by the pointer in the response.

The hardware configuration and basic operation of the network management system can be similar as in known network management systems, which are modified to implement the operations of the invention, which are described in more detail in relation to the network management system in FIG. 4. A network management system can be either centralized or decentralized. In FIG. 1, the simplified network management system comprises four parts: communication part CP1, application part AP1, data part DP1 and user interface UI. The communication part CP1 is responsible for maintaining the connections from operation and maintenance to network elements. The application part AP1 maintains the connections to the work stations of the user interface. The application part AP1 also includes the operation and maintenance applications concerning fault, configuration and performance management, for instance. Network management data is stored in the data part DP1. The data part DP1 collects and stores data arriving from the application part AP1 or connection part CP1. The user interface UI comprises one or more work stations through which the operator can manage the whole network. Through the user interface UI the operator can for instance monitor the operation of the network. The network management system can be implemented by various servers and terminals which are connected to each other by e.g. a local area network.

Network elements NE1, NE2, NE3 can be any elements of the network. In a mobile communications network, for example, they can be base stations, mobile services switching centres, and/or various registers, such as home location registers. Network elements can also be elements which do not belong to the network itself and to which the network management system provides an interface and monitoring. Such an element is e.g. a short message centre. A network element has to be an addressable element so that the network management system can be in connection with it.

For the sake of clarity, FIG. 1 only shows one network element NE2 in more detail. In network management, a single network element NE2 comprises an agent program Ag and a management information base MIB. In the following, the agent program is called an agent. The agent Ag functions as intermediary between the network management system and the management information base. For example, it receives command requests from the network management system and as responses, it transmits command responses. The agent Ag can also transmit spontaneous responses to the network management system. A spontaneous response can be generated for instance when the variable value determined by the network element manufacturer in the management information base exceeds the threshold value. A response refers herein to all the information transmitted by the network element to the network management system independent of the reason for its transmission or its content. The agent and the network management system use a network management protocol, e.g. SNMP or CMIP, in their mutual data transmission. The used protocol has, however, no significance for the invention.

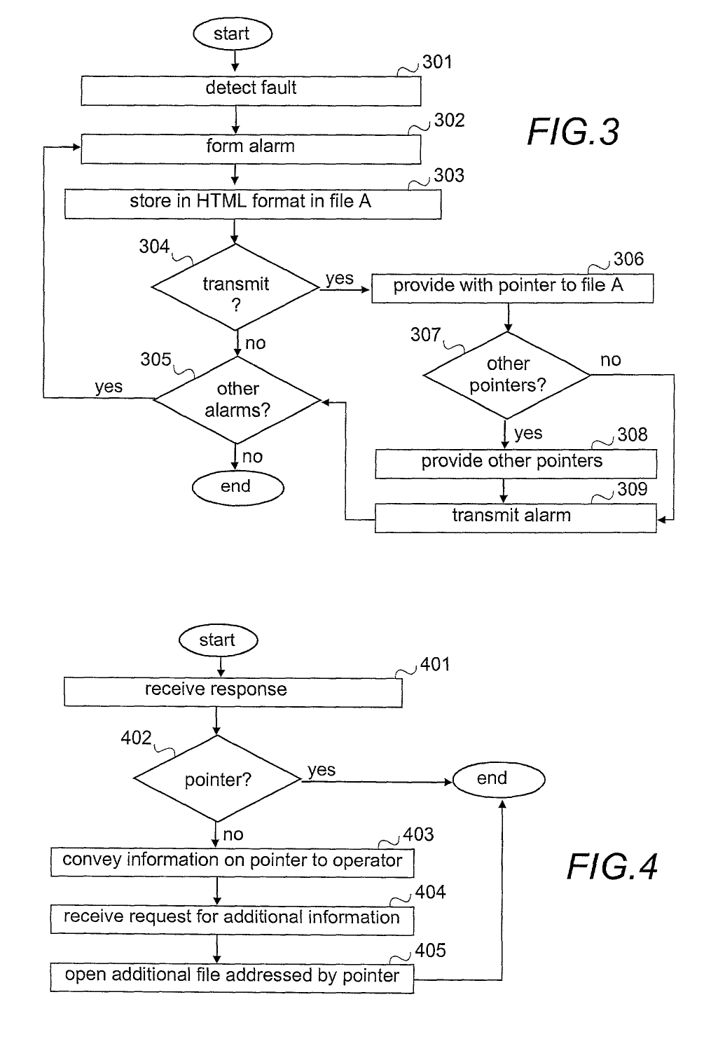

Functional parts of the network element are a connection part CP2, an application part AP2 and a memory M. By means of the connection part the network element receives, transmits and conveys information to and from other network elements and the network management system. The agent utilizes the connection part when transmitting responses. The application part performs the functions and operations of the network element, such as the functions and operations of the agent. The hardware configuration and basic operation of the network element do not have to be changed. The network element is just modified to implement the functions of the invention that are described in more detail in respect of the network element in FIGS. 2 and 3. The memory comprises the management information base MIB and the necessary files, e.g. a computer log file.

As can be noted from above, the network management according to the invention requires relatively small changes to the current network elements and network management systems. Changes can be carried out as updated software routines and/or application-specific integrated circuits (ASIC). Some network elements may further need more memory.

FIG. 2 shows a simplified block diagram of the operation of a network element according to the invention. In step 201, the network element performs a function. The function may concern the network management. Such functions are e.g. fault detection, running of a diagnostics report or a load report and transmission of an alarm. However, the function does not need to be related to network management, but it can also be a relaying of a call set-up request, for example. In step 202 the network element stores the information concerning the function in a predetermined location in a predetermined form. Information can also be stored in various different locations and even in various forms. It is, however, most preferable to use the same form of storing. For example, if it deals with fault detection, the information on the detected fault is stored in the fault file in the HTML format (Hypertext Markup Language), for example. The information concerning the fault can also be stored in a computer log file. The connection of a call set-up request is preferably stored in the computer log file and the diagnostics report formed in result of running a diagnostics program in the file reserved for it. The functions as well as the information concerning which information is stored where and in which form can be freely determined. The information can be maintained centralized or decentralized in the network, and it is worthwhile to maintain part of the information in several network elements, and part in one network element, for example.

In step 203 the network element checks, whether the function requires that a response about it is transmitted to the network management system. It can be freely determined by means of a variety of conditions, when the response is transmitted. For example, an alarm does not have to be transmitted about all faults, but whenever a diagnostics report is finished, that information is transmitted to the network management system. Usually, when it deals with a function that has nothing to do with network management, e.g. the relaying of a call set-up request, a response is not transmitted to the network management system. If a response is not transmitted, the operation is finished.

If a response is transmitted to the network management system, the network element provides the response with the determined pointer/s in step 204. For example, some alarms are only provided with the pointer of the fault file, but other alarms can be provided with both the pointer of the fault file and the pointer to the appropriate location in the manual of the network element. Pointers are preferably Internet, or URL (uniform resource locator), addresses or the like, which identify the file or the directory and the protocol required for their use. Different pointers of the same response can address to various network elements and the pointer does not have to address to the transmitting network element at all. After the response has been provided with a pointer or pointers, it is transmitted to the network management system in step 205.

All specifications described in connection with FIG. 2 can be performed by the network element manufacturer. It is also possible that the operator performs at least some specifications by means of the network management system. It can for example provide a request for an execution report with a pointer in a location where the network element is requested to store the information. The network element is thus adapted to store the additional information in the location indicated by the pointer in the request. Some of the specifications can be performed by the network element manufacturer and some by the operator. For example, the manufacturer can determine faults, the location where to store the fault detection and which pointers are provided in the alarm describing the fault, and the operator determines, when the alarm describing the fault is transmitted.

In an embodiment, the functionality described in FIG. 2 is only implemented in connection with functions relating to network management. Then the checking in step 203 can be left out, if a response is always transmitted to the network management system.

In an embodiment, the pointer is only provided in alarms, and other responses are transmitted without the pointer. In such an embodiment, it is checked after step 203 whether the response is an alarm, and if it is, it is moved to step 204 to provide the alarm with the pointer.

FIG. 3 is a flow chart showing a simpler example of the operation of a network element according to the invention in connection with fault detection. In the example of the FIGURE it is assumed that one fault can cause various different alarms. It is also assumed that alarms concerning a specific fault are stored in the same fault file. In the example of FIG. 3, it is further assumed that the network element utilizes the correlation of alarms. Because of the correlation, instead of five alarms only one alarm is transmitted, for example. By means of the invention the original alarms are easily detected, i.e. the reason why this alarm was transmitted and what the background of the transmitted alarm is.

FIG. 3 starts with the situation in which a fault is detected in the network element in step 301. In step 302 an alarm is formed, which is stored in the fault file A in step 303. Simultaneously the information substantially relating to the alarm is stored. The information to be stored and the fault file are determined by e.g. the network element manufacturer. The storage is performed in a predetermined form, e.g. in the HTML format. Thereafter, it is checked in step 304, whether the alarm is transmitted to the network management system. In other words, it is checked whether a condition or some of the conditions relating to the transmission of an alarm is/are fulfilled.

The invention does not restrict the determination of the conditions in any way. The condition may be e.g. the priority of an alarm, or the fault can be determined in such a manner that no alarms are transmitted about it, or a threshold value can be determined, after the exceeding of which value the alarm is transmitted. The threshold value can be determined such that every tenth alarm is transmitted, for example. The condition can also be determined such that if an alternative route falls out, the alarm is only transmitted when it was the only available route.

If it is detected in step 304 that the alarm is not transmitted to the network management system, it is checked in step 305 whether the fault causes any other alarms. If the fault causes other alarms, it is continued from step 302 by forming the next alarm. If all alarms relating to the fault have been handled, the operation is finished.

If it is detected in step 304 that the alarm is transmitted to the network management system, the alarm is provided with the pointer of the file A, preferably an Internet pointer, in step 306. Thereafter, it is checked in step 307, whether it deals with an alarm which is to be provided with other pointers as well. If this is the case, the alarm is provided with the other pointers in step 308, and the alarm is transmitted to the network management system in step 309. The pointers in an alarm do not need to be of the same type, and they can address to various network elements. When the alarm has been transmitted, it is moved to step 305 to check whether other alarms, which have not been handled, are related to the fault.

If only a pointer to the file A is provided in the alarm, it is moved from step 307 straight to step 309, from which it is proceeded as described above.

In a preferred embodiment of the invention, each alarm can be transmitted to the network management system. In such an embodiment the checking in step 304 is not performed, but it is moved from step 303 straight to step 306.

In a preferred embodiment of the invention, all alarms to be transmitted are not necessarily provided with a pointer to the file A, but a pointer to a specific section in the manual, for example. In such an embodiment step 306 is left out, and in step 308 it is checked which pointers are to be provided in the alarm and it/they is/are provided in step 309.

FIG. 4 shows the operation of a network management system according to the invention in an embodiment in which the network management system is able to communicate with both the responses including pointers and the responses of the current type. This provides the advantage that the network may simultaneously include both old network elements, to which the operation of the invention has not yet been updated, and network elements with the operation of the invention.

In FIG. 4, a response is received in the network management system in step 401. In step 402 it is checked whether the response included at least one pointer. If the response did not include a pointer, it is continued according to the prior art. If the response did include a pointer, the information on the pointer is conveyed in step 403 by means of a user interface to the operator. For example, when an alarm described in connection with FIG. 3 occurs on the display of the user interface, the words “additional information” (pointer to the file A) and “manual” (pointer to the manual), or only one of them, simultaneously occur on the display. The information on the pointer/s can also be hidden under the alarm. The manner in which the pointer is indicated to the operator has no relevance to the invention, as long as it is somehow indicated, at the latest when the operator starts to examine the response.

In step 404, a request for additional information, i.e. the indication of the operator needing to get to know the additional information behind the pointer, is received via the user interface. The operator has, for example, clicked the mouse button on word “additional information” or “manual”. Thereafter in step 405 the additional file addressed by the pointer is opened. Thus, the operator is provided with the desired information in a readable and simple form and no separate remote session need to be established. In addition, the laborious information search and scanning of manuals can be avoided. For the operator this means less work. Steps 404 and 405 are always repeated when the operator indicates so. The operator can, for example, open the measurement data on his display and also that section of the manual which includes the recommended values for the measurement data. Steps 404 and 405 are continuously repeated until the operator finishes the handling of the response.

The order of the steps described in FIGS. 2, 3 and 4 may differ from what is said above and the steps may also occur concurrently. Between the steps, other steps can be performed, which are not shown in the figures. Some of the steps shown in the figures can also be left out. For example, the checking in step 402 can be left out, if all responses include a pointer. Further, the above embodiments can be combined, as long as the response to be transmitted is provided with a pointer indicating the location where to find additional information.

It is obvious to a person skilled in the art that as the technology develops, the basic idea of the invention can be implemented in a variety of ways. The invention and the embodiments thereof are thus not restricted to the above examples, but they may vary within the scope of the claims.

1. A method of data transmission to a network management system, comprising the steps of:
providing a response to be transmitted to the network management system with at least one pointer indicating the location where to find additional information; and
transmitting the response to the network management system.

2. The method of claim 1, further comprising the steps of:
receiving the response in the network management system; and
transmitting the information on a pointer to a network management system user.

3. The method of claim 2, further comprising the steps of:
receiving a request for additional information in the network management system; and
opening the additional information in the location indicated by the pointer.

4. The method of claim 1, further comprising the steps of:
performing a function relating to network management in a network element; and
storing the information concerning the function as additional information in a predetermined location in a predetermined form.

5. The method of claim 1, further comprising the steps of:
performing a function relating to network management in a network element; and
storing the information concerning the function as additional information in the location determined by the network management system.

6. The method of claim 1, wherein the response is an alarm transmitted to the network management system.

7. The method of claim 1, wherein the pointer is an Internet address or the like, which identifies both the location and the necessary protocol.

8. A method of data transmission to a network management system, comprising the steps of:
providing a response to be transmitted to the network management system with at least one pointer indicating the location where to find additional information, the pointer being an Internet address or the like, which identifies both the location and the necessary protocol; and
transmitting the response to the network management system.

9. A method of data transmission to a network management system, comprising the steps of:
providing an alarm to be transmitted to the network management system with at least one pointer indicating the location where to find additional information, the pointer being an Internet address or the like, which identifies both the location and the necessary protocol; and
transmitting the alarm to the network management system.

10. A method of data transmission to a network management system, comprising the steps of:
performing a function relating to network management in a network element;
storing the information concerning the function as additional information in a predetermined location in a predetermined form;
providing a response to be transmitted to the network management system with at least one pointer indicating the location where to find the additional information, the pointer being an Internet address or the like, which identifies both the location and the necessary protocol;
transmitting the response to the network management system;
receiving a request for the additional information in the network management system; and
opening the additional information in the location indicated by the pointer.

11. A method of data transmission to a network management system, comprising the steps of:
performing a function relating to network management in a network element;
storing the information concerning the function as additional information in a predetermined location in a predetermined form;
providing a response to be transmitted to the network management system with at least one pointer indicating the location where to find the additional information;
transmitting the response to the network management system;
receiving a request for the additional information in the network management system; and
opening the additional information in the location indicated by the pointer.

12. A method of data transmission to a network management system, comprising the steps of:
performing a function relating to network management in a network element;
storing the information concerning the function as additional information in the location determined by the network management system;
providing a response to be transmitted to the network management system with at least one pointer indicating the location where to find the additional information, the pointer being an Internet address or the like, which identifies both the location and the necessary protocol;
transmitting the response to the network management system;
receiving a request for the additional information in the network management system; and
opening the additional information in the location indicated by the pointer.

13. A method of data transmission to a network management system, comprising the steps of:
performing a function relating to network management in a network element;
storing the information concerning the function as additional information in the location determined by the network management system;
providing a response to be transmitted to the network management system with at least one pointer indicating the location where to find the additional information;
transmitting the response to the network management system;
receiving a request for the additional information in the network management system; and
opening the additional information in the location indicated by the pointer.

14. A network element of a telecommunications network, the network element being capable to be in connection with the network management system of the telecommunications network by transmitting to the network management system at least one response provided with a pointer indicating the location where to find additional information.

15. A network element of a telecommunications network, the network element being capable to store additional information in a predetermined location and to be in connection with the network management system of the telecommunications network by transmitting to the network management system at least one response provided with a pointer indicating the location where to find the additional information.

16. A network element of a telecommunications network, the network element being capable to store additional information in a predetermined form and to be in connection with the network management system of the telecommunications network by transmitting to the network management system at least one response provided with a pointer indicating the location where to find the additional information.

17. A network management system of a telecommunications network, the network management system being capable to receive responses from network elements of the telecommunications network and to identify a pointer in a response, the pointer indicating where to find additional information.

18. The network management system of claim 17, wherein the network management system is adapted to open the additional information in the location indicated by the pointer in response to a received request for the additional information.

19. The network management system of claim 17, wherein the network management system is adapted to identify the pointer in the response, if it is an Internet address or the like which identifies both the location and the required protocol.

20. A network management system of a telecommunications network, the network management system being capable to receive responses from network elements of the telecommunications network; to identify a pointer in a response, the pointer indicating where to find additional information; and to open the additional information in the location indicated by the pointer in response to a received request for the additional information.

21. A network management system of a telecommunications network, the network management system being capable to receive responses from network elements of the telecommunications network and to identify a pointer in a response, the pointer indicating where to find additional information if the pointer is an Internet address or the like which identifies both the location and the required protocol.
